(19) United States
(12) Patent Application Publication
(10) Pub. No.: US 2005/0055320 A1
(43) Pub. Date: Mar. 10, 2005

(54) Mail processing system and method

(76) Inventors: Thomas Sheng, Hsinchu (TW); Bo-Hsiang Wang, Taiping City (TW)

Correspondence Address: BIRCH STEWART KOLASCH & BIRCH, PO BOX 747, FALLS CHURCH, VA, 22040-0747, US

(21) Appl. No.: 10/929,550

(22) Filed: Aug. 31, 2004

(30) Foreign Application Priority Data
Sep. 8, 2003 (TW) 092124698
Sep. 17, 2003 (TW) 092125638

(51) Int. Cl. G06F 17/00

(52) U.S. Cl. 705/406

(57) ABSTRACT

A mail processing system includes a document scanner and a mail processing machine. The document scanner includes a scanning module, a processor and a network interface. The scanning module scans a document set and obtains to-be-delivered mail information. The processor processes the mail information into a first digital signal. The network interface is for outputting the first digital signal. The mail processing machine receives the first digital signal coming from the document scanner via a network, and produces a deliverable mail package according to the first digital signal.

### BACKGROUND OF THE INVENTION

1. Field of the Invention

The invention relates to a mail processing system and a method therefor, and more particularly to a mail processing system and a method using a network in conjunction with an application specific scanner and a mail processing machine.

2. Description of the Related Art

Although advertisement letters can be conveniently sent via E-mail or FAX, the conventional post mail still plays an important role because it is simple, convenient and clear, as well as it can be sent to the users having no information products such as computers.

In a company having to send a lot of advertisement letters, it is possible to pack and then send the advertisement letters manually, or to use a mail processing machine instead of the human work.

On the other hand, in a company having to send a lot of invoices, it is preferred to use the conventional post mail because some originals are needed.

In the conventional mail processing machine, after the letters and envelopes are printed, an automatic document folding device is typically used to fold the letters, and then an automatic packing device is used to pack the letter into the envelope, on which the receiptor information has been printed. When the mail processing machine is used, the user usually has to use the word processing software and typesetting software to process and then transfer the data of the electric files to the mail processing machine. Thus, the user cannot use the mail processing machine to process the handwritten letter into the deliverable state.

On the other hand, when the user wants to deliver the mail, which is processed by the mail processing machine, to a foreign country or other zones, he or she has to spend a lot of money. In addition, as the deliver distance gets longer, the deliver time gets longer. So, the mail delivering is inefficient in time-saving.

### SUMMARY OF THE INVENTION

It is therefore an object of the invention to provide a mail processing system and a method therefor, which are capable of saving the mail cost and shortening the mailing time.

To achieve the above-mentioned object, the invention provides a mail processing system, which includes a document scanner and a mail processing machine. The document scanner includes a scanning module, a processor and a network interface. The scanning module scans a document set and obtains to-be-delivered mail information. The processor processes the mail information into a first digital signal. The network interface is for outputting the first digital signal. The mail processing machine receives the first digital signal coming from the document scanner via a network and produces a deliverable mail package according to the first digital signal. The invention also provides a mail processing method.

Using the above-mentioned mail processing system may effectively shorten the mail delivering time and reduce the delivering cost.

### BRIEF DESCRIPTION OF THE DRAWINGS

FIG. 1 is a block diagram showing a mail processing system according to a preferred embodiment of the invention.

### DETAILED DESCRIPTION OF THE INVENTION

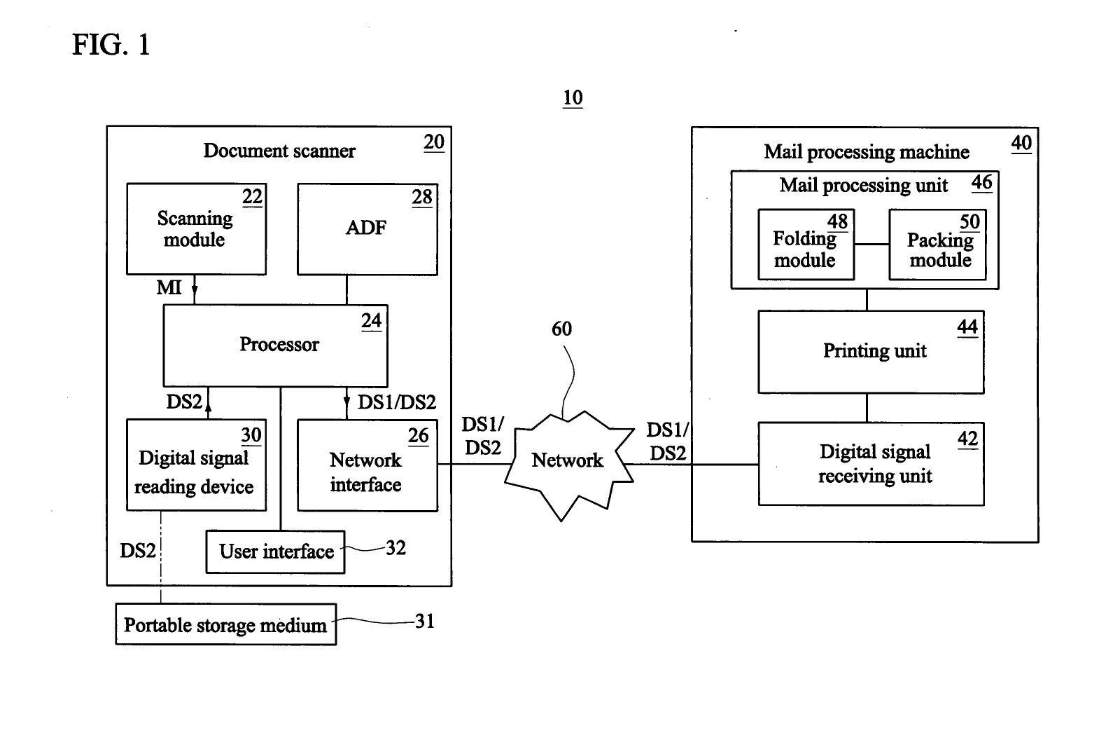

FIG. 1 is a block diagram showing a mail processing system according to a preferred embodiment of the invention. Referring to FIG. 1, the mail processing system 10 of this embodiment includes a document scanner 20 and a mail processing machine 40. The document scanner 20 includes a scanning module 22, a processor 24, a network interface 26, an automatic document feeder (ADF) 28, a digital signal reading device 30 and a user interface 32.

The scanning module 22 scans a document set and obtains to-be-delivered mail information MI, which usually may be stored as an image file. Typically, the document set may be a single-page or a multi-page document set, and also may be a reflective or transmittive type document set. The processor 24 processes the mail information MI into a first digital signal DS1 that may be transferred via a network, and also may be configured to control the operation of the document scanner 20. The network interface 26 is for outputting the first digital signal DS1. The automatic document feeder 28 is an optional member for automatically feeding the document set for the scanning module 22 to scan. It is more convenient when the document set is the multi-page document set.

The digital signal reading device 30 is an optional member for reading a second digital signal DS2 of a portable storage medium 31 and transferring the second digital signal DS2 to the processor 24. For example, the digital signal reading device 30 may be a card reader, a floppy disk drive, an optical disk drive or a connection port, such as a USB connection port, which may access the data of a portable hard disk.

The processor 24 outputs the second digital signal DS2 through the network interface 26. The mail processing machine 40 may further receive the second digital signal DS2 coming from the document scanner 20 via the network 60, and produce another deliverable mail package according to the second digital signal DS2. The user interface 32 is also an optional member such as a keyboard or mouse, wherein the user may operate the keyboard or mouse so as to control the digital signal reading device 30 to read the second digital signal DS2 or the first digital signal DS1 according to a control signal SU1.

Therefore, when the user needs to mail the prepared document, he or she may scan the prepared letter (document set) using the document scanner 20, wherein the document set may include receiptor data and mail content data, and may further include sender data. The mail information MI is transferred to the processor 24, which processes the mail information MI into the first digital signal DS1. Then, the first digital signal DS1 is outputted via the network interface 26 and the network 60, which may be the Intranet or Ethernet.

Thereafter, the mail processing machine 40 may receive the first digital signal DS1 coming from the document scanner 20 via the network 60, and produce the deliverable mail package according to the first digital signal DS1. The so-called deliverable mail package includes, without limitation to, the package placed into the envelope and the package formed by folding the single document set. If the package placed into the envelope is to be produced, it is preferred that the receiptor data and the mail content data are printed separately.

The mail processing machine 40 includes a digital signal receiving unit 42, a printing unit 44 and a mail processing unit 46. The digital signal receiving unit 42 receives the first digital signal DS1 via the network 60, the printing unit 44 prints a mail document set according to the first digital signal DS1, and the mail processing unit 46 processes the mail document set into the deliverable mail package. The mail processing unit 46 includes a folding module 48 for folding the mail document set, and a packing module 50 for packing the mail document set. It is to be noted that the operations of the packing module 50 can include, without limitation to, the operation for placing and packing the letter into the envelope, as well as the operation for packing the folded mail document set coming from the folding module 48. Furthermore, the packing module 50 may be omitted. In this case, the folding module 48 may directly fold and pack the mail document set into the mail package.

In another embodiment, the scanned mail information MI is one of the receiptor data and the mail content data. The processor 24 processes the mail information MI into the first digital signal DS1 according to the supplement information, which includes the other one of the receiptor data and the mail content data. For example, the scanned mail information MI only includes the mail content data, and the user may operate the user interface (e.g., keyboard) 32 to input a set of or multiple sets of supplement information SU2 containing the receiptor data to the processor 24. Then, the processor 24 combines the receiptor data with the mail content data to form the first digital signal DS1. Next, the mail processing machine 40 can produce a deliverable mail package containing the mail content data and the receiptor data according to the first digital signal DS1.

Alternatively, a set of or multiple sets of the supplement information may be built in the processor 24 so that the user can easily output the first digital signal DS1 to the mail processing machine 40 according to the supplement information and the mail information MI. Or, the supplement information may also come from the digital signal reading device 30, which can read the supplement information stored in the portable storage medium 31. In this case, the user can use the mail processing system to produce the deliverable mail package according to the electric file stored in, for example, the floppy disk, in conjunction with the to-be-delivered mail content data. The supplement information may further contain the sender data so as to facilitate the showing of the sender information on the mail package. The above-mentioned embodiment really provides a lot of convenience to the company having to send mails to some fixed customers frequently.

The invention also provides a mail processing method used in the above-mentioned mail processing system. The method includes the following steps. First, the scanning module 22 of the document scanner 20 is used to scan a document set and obtain to-be-delivered mail information MI. Then, the processor 24 of the document scanner 20 is used to process the mail information MI into a first digital signal DS1. Alternatively, when the mail information MI is one of receiptor data and mail content data, it is possible to utilize the processor 24 to process the mail information MI into the first digital signal DS1 according to the supplement information, wherein the supplement information includes the other one of the receiptor data and the mail content data. The supplement information may also come from the user interface 32 or the portable storage medium 31 or even may be built in the processor 24, as mentioned hereinabove.

Thereafter, the network interface 26 of the document scanner 20 is utilized to output the first digital signal DS1 via the network 60. Then, the digital signal receiving unit 42 of the mail processing machine 40 is utilized to receive the first digital signal DS1 via the network 60. Next, the printing unit 44 and the mail processing unit 46 are utilized to produce a deliverable mail package according to the first digital signal DS1. For example, it is possible to utilize the printing unit 44 to print a mail document set according to the first digital signal DS1, and utilize the mail processing unit 46 to process the mail document set into the deliverable mail package. This may be achieved by using the folding module 48 to fold the mail document set and the packing module 50 to pack the mail document set.

Using the above-mentioned mail processing system can effectively shorten the mail delivering time and reduce the delivering cost. The details will be described with reference to two examples.

### EXAMPLE 1

In this example, it is assumed that the document scanner 20 is set at the head office in Taiwan and the mail processing machine 40 is set at the affiliate in U.S.A. The user may transfer the mail from the head office in Taiwan to the affiliate in U.S.A. according to the mail processing system, and then the mail may be delivered via the domestic post mail from the affiliate in U.S.A. Thus, the delivering cost of the air mail or express mail may be eliminated, and the delivering time from Taiwan to U.S.A. may be greatly shortened.

### EXAMPLE 2

In this example, it is assumed that various mail processing machines 40 are set at various post offices. The user may purchase the document scanner 20 and use the document scanner 20 to scan the to-be-delivered document. Then, the mail document may be transferred to the mail processing machine 40 in some post office, which may be a foreign one or a domestic one, via the network. Thus, the user can deliver the mail without going to the post office, and a lot of time and mailing cost may be saved.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. A mail processing system, comprising:
a document scanner, which comprises:
a scanning module for scanning a document set and obtaining to-be-delivered mail information;
a processor for processing the mail information into a first digital signal; and
a network interface for outputting the first digital signal; and
a mail processing machine for receiving the first digital signal coming from the document scanner via a network, and producing a deliverable mail package according to the first digital signal.

2. The system according to claim 1, wherein the document scanner further comprises:
an automatic document feeder for automatically feeding the document set for the scanning module to scan.

3. The system according to claim 1, wherein the document scanner further comprises:
a digital signal reading device for reading a second digital signal of a portable storage medium and transferring the second digital signal to the processor such that the processor outputs the second digital signal via the network interface, wherein the mail processing machine can further receive the second digital signal coming from the document scanner via the network, and produce another deliverable mail package according to the second digital signal; and
a user interface, which is controlled by a user to control the digital signal reading device to read the second digital signal.

4. The system according to claim 1, wherein the mail information comprises receiptor data and mail content data.

5. The system according to claim 4, wherein the mail information further comprises sender data.

6. The system according to claim 1, wherein the mail processing machine comprises:
a digital signal receiving unit for receiving the first digital signal via the network;
a printing unit for printing a mail document set according to the first digital signal; and
a mail processing unit for processing the mail document set into the deliverable mail package.

7. The system according to claim 6, wherein the mail processing unit comprises:
a folding module for folding and packing the mail document set into the deliverable mail package.

8. The system according to claim 6, wherein the mail processing unit comprises:
a folding module for folding the mail document set; and
a packing module for packing the mail document set.

9. The system according to claim 1, wherein the mail information is one of receiptor data and mail content data, and the processor processes the mail information into the first digital signal according to supplement information, which comprises the other one of the receiptor data and the mail content data.

10. The system according to claim 9, wherein the supplement information is built in the processor.

11. The system according to claim 9, wherein the document scanner further comprises a user interface, according to which a user inputs the supplement information to the processor.

12. The system according to claim 11, wherein the user interface is a keyboard.

13. The system according to claim 9, wherein the document scanner further comprises a digital signal reading device for reading the supplement information stored in a portable storage medium.

14. The system according to claim 9, wherein the supplement information further comprises sender data.

15. A mail processing method, comprising the steps of:
scanning a document set and obtaining to-be-delivered mail information using a scanning module of a document scanner;
processing the mail information into a first digital signal using a processor of the document scanner;
outputting the first digital signal via a network using a network interface of the document scanner;
receiving the first digital signal via the network using a mail processing machine; and
producing a deliverable mail package according to the first digital signal using the mail processing machine.

16. The method according to claim 15, wherein the step of producing the deliverable mail package comprises the steps of:
printing a mail document set according to the first digital signal; and
processing the mail document set into the deliverable mail package.

17. The method according to claim 16, wherein the step of processing the mail document set into the deliverable mail package comprises the steps of:
folding the mail document set; and
packing the mail document set.

18. The method according to claim 15, wherein the mail information is one of receiptor data and mail content data, and the step of processing the mail information into the first digital signal comprises the step of:
processing the mail information into the first digital signal according to supplement information using the processor, wherein the supplement information comprises the other one of the receiptor data and the mail content data.

19. The method according to claim 18, wherein the supplement information is built in the processor.

20. The method according to claim 18, further comprising the step of:
enabling the processor to receive the supplement information, which is inputted by a user and coming from a user interface.

21. The method according to claim 18, further comprising the step of:
enabling the processor to receive the supplement information, which is stored in a portable storage medium.
